(19) United States
(12) Patent Application Publication
(10) Pub. No.: US 2010/0287181 A1
(43) Pub. Date: Nov. 11, 2010

(54) Method for Searching Content by a Soap Operation

(76) Inventors: Tae Bum Lim, Gyeonggi-do (KR); Jong Sul Lee, Gyeonggi-do (KR); Seok Pil Lee, Gyeonggi-do (KR); Kyoung Ro Yoon, Seoul (KR); Saim Shin, Seoul (KR)

Correspondence Address: North Star Intellectual Property Law, PC, P.O. Box 34688, Washington, DC, 20043, US

(21) Appl. No.: 12/307,177

(22) PCT Filed: Sep. 2, 2008
(86) PCT No.: PCT/KR2008/005141

§ 371 Date: Jul. 13, 2010

(30) Foreign Application Priority Data
Sep. 3, 2007 (KR) 10-2007-0088759

(51) Int. Cl. G06F 17/30

(52) U.S. Cl. 707/769; 707/E17.014

(57) ABSTRACT

Provided is a method for searching contents using a Simple Object Access Protocol (SOAP) operation. The method includes adding a request element field type in order to request various content searches through a comparison operation in a SOAP query operation, and transmitting a request message of the SOAP query operation to which the request element field type is added to a content service server. The method adds an operator associated with a comparison operation to a corresponding query request field which requests the search result of various contents to a SOAP query operation, thereby enabling to perform a content search by a complex operation expression.

### CROSS REFERENCE TO RELATED APPLICATIONS

This patent application claims priority to international patent application PCT/KR2008/005141 filed on Sep. 2, 2008, and Korean patent application 10-2007-88759 filed on Sep. 3, 2007, which are incorporated by reference herein.

### BACKGROUND

The present disclosure relates to a contents searching service, and in particular, to a method for searching contents using a Simple Object Access Protocol (SOAP) operation.

Recently, due to the full-scale providing of a digital broadcast service, studies have been made on a technology for providing a custom broadcast service in multi-channel and multi-medium environments. As an example, TV-Anytime being nongovernmental global standard is a standard protocol for providing an Anytime service that enables users to store desired contents and to view the stored contents by matching user's preference information with metadata on the basis of the metadata representing the description information of contents.

As described above, the metadata are the description information of contents. In the TV-Anytime, the metadata include a content-based description and Electronic Program Guide (EPG) information defined in MPEG-7, and enable users to easily search and select desired contents. A metadata standard is configured with two parts. A part A defines a format for describing the metadata, i.e., a schema, and uses eXtensible Markup Language (XML) based MPEG-7 Description Definition Language (DDL) (ISO/IEC 15938-2). A part B relates to the transmission of the metadata, and includes Binary Format for MPEG-7 (ISO/IEC 15938-1), fragmentation model, encapsulation and indexing schemes.

FIG. 1 illustrates a configuration of a general TV-Anytime metadata. The general TV-Anytime metadata include program description metadata and user description metadata, wherein the program description metadata are configured with content description metadata and instance description metadata. The metadata for one program are a content identifier called Content Reference Identifier (CRID) and are interconnected.

The content description metadata are generated by a content creator, and include a program title, a genre, an abstract, a critic review and the like. The instance description metadata are generated by a content provider, and include a location (broadcast time, channel, Uniform Resource Locator (URL) and the like), a use rule, a delivery parameter and the like. The user description metadata include a user preference, a usage history, a personal bookmark and the like, and are generated by a user.

The TV-Anytime standard defines two types of metadata web services for providing interactive metadata service through a return path, wherein each of the metadata web services is a well-defined behavior and a remote procedure for an input/output set. In XML based Web Service Description Language (WSDL), the remote procedure is defined as a SOAP operation type, and includes a get_Data operation for the search of the metadata and a submit_Data operation for a user description submission. For example, the above-described SOAP protocol is an XML communication protocol enabling to access to objects in a distributed environment.

A request/response type used in a TV-Anytime metadata service is defined in a name space of “urn:tva:transport:2002” wherein the name space is provided as a tool for the verification of various messages. Types defined in a metadata spec and a content referencing standard are referred to in a transport name space. A schema fragment is defined in the name space, and a name space provider is defined as “tns:”?in the schema fragment. A complete XML schema file is tva_transport_types_v10.xsd.

1. get_Data Operation

The get_Data operation provides a function that enables clients to search TV-Anytime data on a program or a program group from a server. Examples of functions that a TV-Anytime metadata provider can provide using the get-Data operation are as follows.
Return content referencing data of the CRID using a CRID list.
   Return the TV-Anytime metadata of the CRID using the CRID list.
Receive a query of a specific metadata attribute (for example, a genre, an actor and the like), and return a program corresponding to the received query.
Respond to a query for a specific time or a specific channel, and return a corresponding program.

The get_Data operation supports all query types in principle, and provides a wide scope of query on a metadata limitation condition.

A. Request Format

Referring to FIGS. 2 to 4, in the get_Data operation, the request format designates three types of parameters to clients and designates an element type returned as a result value of a query (search) to a RequestedTables type.

B. Response Format

Referring to FIG. 5, the response format of the get_Data operation include 0 or at least one XML instance document on elements (TVAMain, ContentReferencingTable, InvalidFragments), and returns a query result value according to the RequestedTables type requested by the request format.

As described above, upon request of a search query, the TV-Anytime operation which is defined at present performs the comparison search of a character string on a field value such as a specific element and a specific attribute on which a search is desired.

A related art metadata providing method using the SOAP operation is a method that searches contents according to titles or genres with the fundamental search type and structure of the metadata (for example, a text comparison on a specific field value). However, since a type for representing various output descriptions is not defined, the related art metadata providing method cannot service query contents corresponding to various queries.

### SUMMARY

Therefore, an object of the present disclosure is to provide a method for searching content by a SOAP operation, which enables to easily perform a content query by adding a corresponding query request field requesting various content queries to a SOAP query operation.

Another object of the present disclosure is to provide a method for searching content by a SOAP operation, which enables to receive a service on corresponding contents satisfying a complex operation result using a comparison operation in a SOAP query operation.

According to an aspect, there is provided a method for searching content by a Simple Object Access Protocol (SOAP) operation, the method including: adding a request element field type in order to request various content searches through a comparison operation in a SOAP query operation; and transmitting a request message of the SOAP query operation to which the request element field type is added to a content service server.

The request message further comprises a constant value (ConstantValue) type for allotting only a constant to operands of an arithmetic operation and a comparison operation, and an arithmetic operator (FieldCombination) type of operator information clarifying a content extracting condition.

The SOAP query operation is a get_Data operation.

The request element comprises at least one operator of GTE, GT, LTE, LT, EQ, NE and contain operators.

The SOAP operation performs a comparison operation with other operand using an operation result value of other operator as an operand.

According to another aspect, there is provided a computer-readable storage medium storing a command which performs each operation of a method for searching content by a Simple Object Access Protocol (SOAP) operation.

### BRIEF DESCRIPTION OF THE DRAWINGS

FIG. 1 is a block diagram of a general TV-Anytime metadata.

FIGS. 2 to 4 are exemplary diagrams illustrating a related art request format of the get_Data operation.

FIG. 5 is an exemplary diagram illustrating a related art response format of the get_Data operation.

FIG. 6 illustrates a concept of a metadata distribution operation according to an exemplary embodiment.

FIGS. 7 to 9 are exemplary diagrams illustrating a comparison type applied to an exemplary embodiment.

FIG. 10 is an exemplary diagram for describing a method for searching content by a SOAP operation according to an exemplary embodiment.

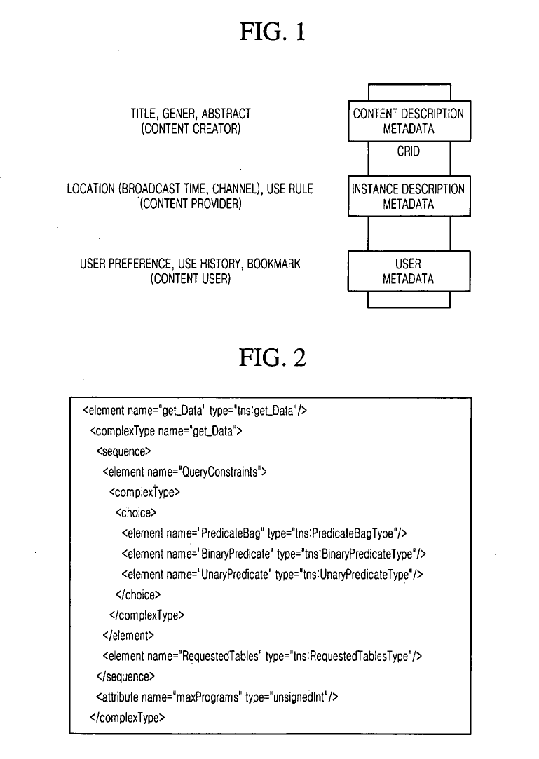

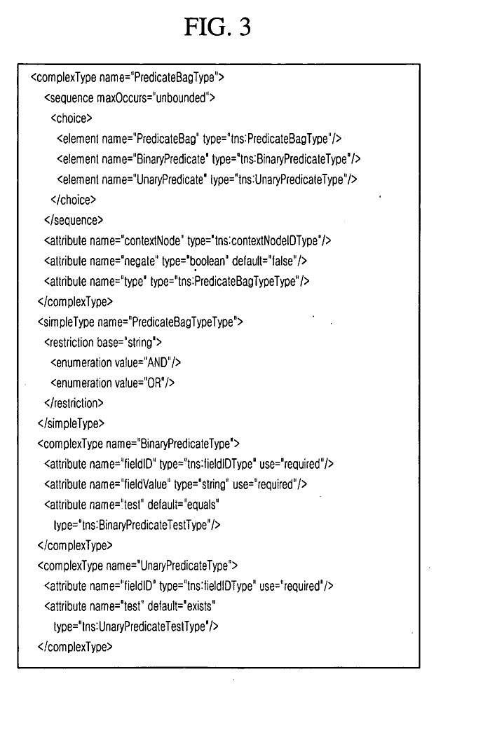

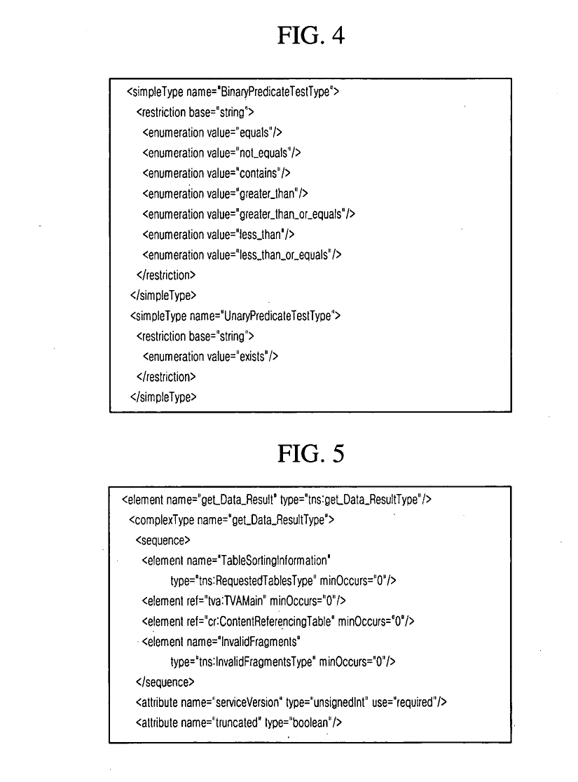

### DETAILED DESCRIPTION

A method for searching content by a SOAP operation according to an exemplary embodiment provides a comparison operation type for a content query search. Accordingly, the method according to an exemplary embodiment has a technical point that enables to perform a complex operation through an intrinsic operation of a comparison operation by adding a request element field type to a SOAP query operation in order to request various content searches through a comparison operation, thereby enabling to search contents according to a comparison operation result.

Hereinafter, specific embodiments will be described in detail with reference to the accompanying drawings. In description below, the specific details of a method for searching content by a SOAP operation according to the present invention are described for providing the more overall understanding of the present invention. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

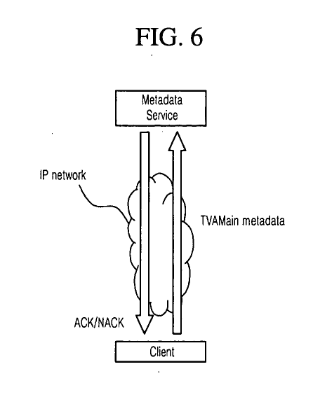

FIG. 6 illustrates a concept of a metadata distribution operation according to an exemplary embodiment.

In a TV-Anytime service, a client transmits a SOAP request message [get_Data( ) Request] by a get_Data operation to a metadata service server through the Internet network (IP Network). At this point, the get_Data operation supports all query types in principle, and provides a wide scope of query on a metadata limitation condition.

In particular, a request element field type is added to a specific field of the get_Data operation through an intrinsic operation of a comparison operation in order to express a complex operation. Then, the metadata service server returns a query result value of the SOAP request message to which the request element field type is added by a SOAP response message [get_Data( )Response].

1. Comparison Operator Type

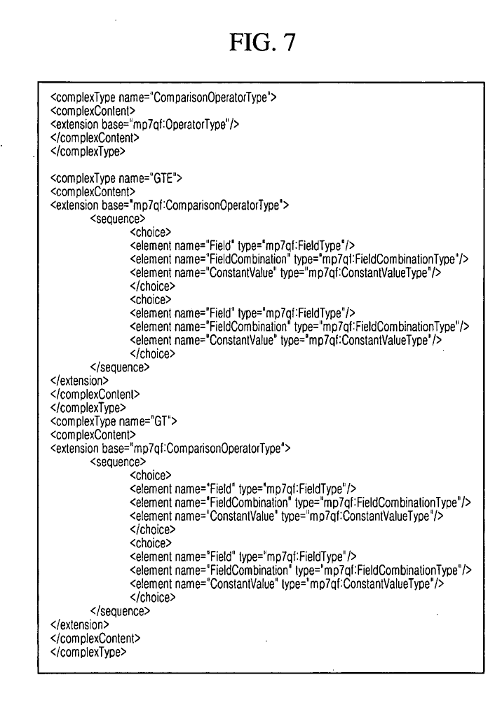

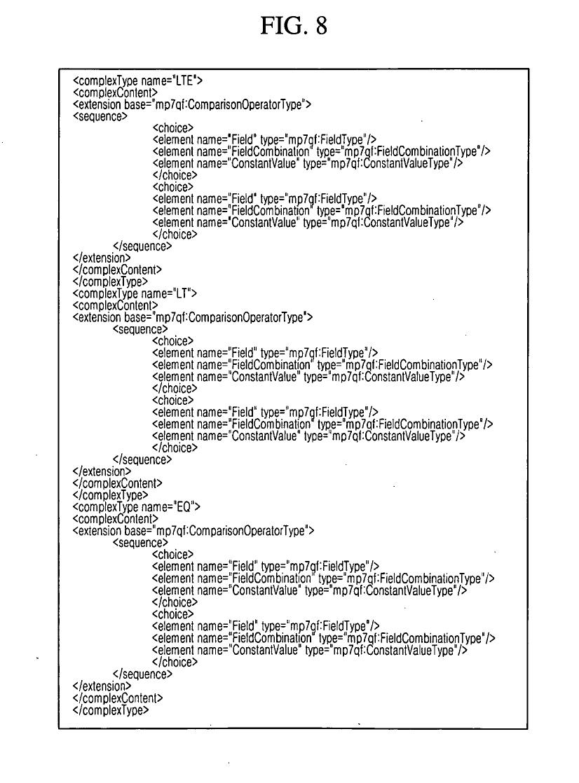

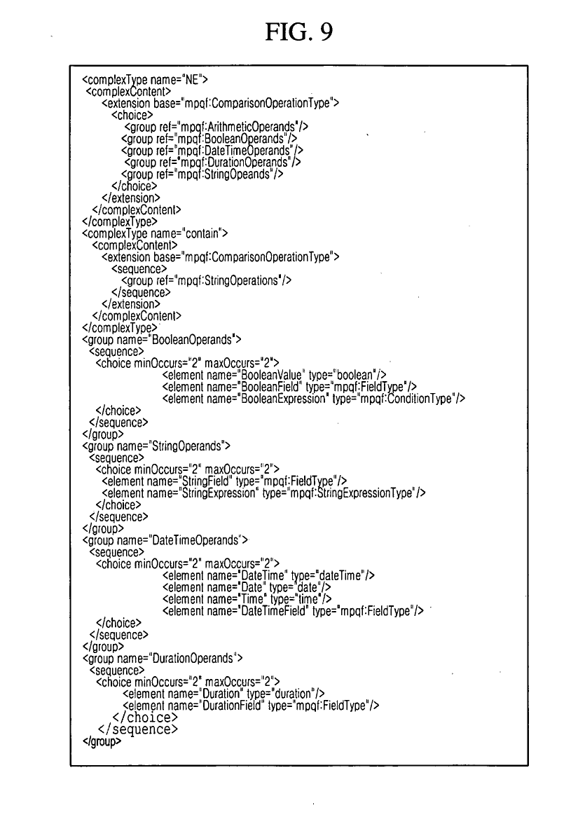

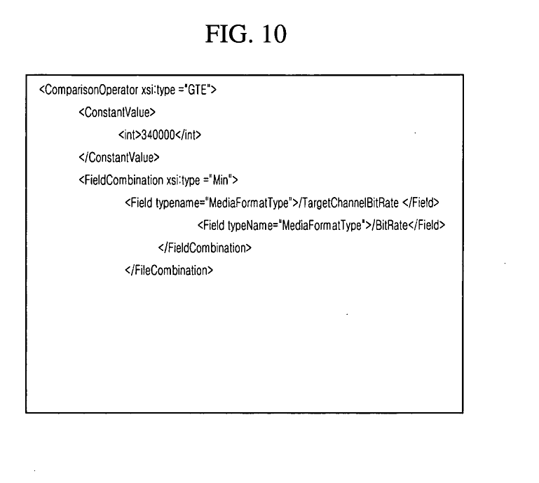

A comparison operator type is defined by extending an operator type, and is an abstract type which is the upper class of all operator types for describing a comparison operation. All comparison operator types must succeed to the comparison operator type as the abstract type. The comparison operators according to an exemplary embodiment must carry a Boolean value as a result. Such a comparison operator type is expressed as illustrated in FIGS. 7 to 9.

The comparison operators of FIGS. 7 to 9 are defined as described in the following Table 1.

TABLE 1

| Name | Definition |
|---|---|
| ComparisonType | ComparisonType is a base type for defining |
| | logic operators. |
| GTE | GTE is a class defining a GTE operation in |
| | a query based on ComparisonType. In a case |
| | where two operands are disposed in the GTE |
| | operation, a GTE operator means to determine |
| | whether the great or equal relationship |
| | between the two operands is True or False. |
| GT | GT is a class defining a GT operation in a |
| | query based on ComparisonType. In a case where |
| | two operands are disposed in the GT operation, |
| | a GT operator means to determine whether the |
| | great relationship between the two operands is |
| | True or False. |
| LTE | LTE is a class defining an LTE operation in a |
| | query based on ComparisonType. In a case where |
| | two operands are disposed in the LTE operation, |
| | an LTE operator means to determine whether the |
| | little or equal relationship between the two |
| | operands is True or False. |
| LT | LT is a class defining an LT operation in a |
| | query based on ComparisonType. In a case where |
| | two operands are disposed in the LT operation, |
| | an LT operator means to determine whether the |
| | little relationship between the two operands is |
| | True or False. |
| EQ | EQ is a class defining an EQ operation in a |
| | query based on ComparisonType. In a case where |
| | two operands are disposed in the EQ operation, |
| | an EQ operator means to determine whether the |
| | equal relationship between the two operands is |
| | True or False. |
| NE | NE is a class defining an NE operation in a |
| | query based on ComparisonType. In a case where |
| | two operands are disposed in the NE operation, |
| | an NE operator means to determine whether the |
| | non-equal relationship between the two operands |
| | is True or False. |
| Contain | Contain is a class defining a contain operation |
| | in a query based on ComparisonType. The contain |
| | operation is an operation determining whether a |
| | string succeeding a preceding string emerges. |
| | Accordingly, a contain operator include two strings. |

The comparison operators such as GTE, GT, LTE, LT, EQ, NE and contain require elements expressing two operands. Moreover, the comparison operators may have an arithmetic constant value limited by the constant value type as an operand. All operations may have the intrinsic operation expression of the field combination type.

FIG. 10 is an exemplary diagram for describing a method for searching content by a SOAP operation according to an exemplary embodiment.

FIG. 10 is an example of a Min operator and a GTE operator. Referring to FIG. 10, an exemplary embodiment compares a minimum value of the TargetChannelBitRate value of MediaFormatType and the BitRate value of MediaFormatType with an int 340000 value to thereby determine the great or equal relationship between the compared values, and returns a great or equal value.

The above-described SOAP operation according to an exemplary embodiment defines an operation result value of other operator as an operand and performs a comparison operation on the defined operand and other operand, thereby enabling to perform a more complex content query. For example, the SOAP operation according to an exemplary embodiment defines an operation result value of an arithmetic operator as a first operand, defines other operand as a second operand, and performs a comparison operation on the defined operands, thereby querying more complex contents.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

As described above, the present disclosure adds an operator associated with a comparison operation to a corresponding query request field which requests the search result of various contents to a SOAP query operation, thereby enabling to perform a content search by a complex operation expression.

What is claimed is:

1. A method for searching content by a Simple Object Access Protocol (SOAP) operation, the method comprising:
adding a request element field type in order to request various content searches through a comparison operation in a SOAP query operation; and
transmitting a request message of the SOAP query operation to which the request element field type is added to a content service server.

2. The method of claim 1, wherein the request message further comprises a constant value (ConstantValue) type for allotting only a constant to operands of an arithmetic operation and a comparison operation, and an arithmetic operator (FieldCombination) type of operator information clarifying a content extracting condition.

3. The method of claim 1, wherein the SOAP query operation is a get_Data operation.

4. The method of claim 1, wherein the SOAP query operation is a get_Data operation.

5. The method of claim 1, wherein when two operands are disposed in the GTE operator according to the following definition, the SOAP operation determines whether a great or equal relationship between the two operands is True.
```
<complexType name=“GTE”>
<complexContent>
<extension base=“mp7qf:ComparisonOperatorType”>
  <sequence>
    <choice>
    <element name=“Field” type=“mp7qf:FieldType”/>
    <element name=“FieldCombination”
type=“mp7qf:FieldCombinationType”/>
    <element name=“ConstantValue”
    type=“mp7qf:ConstantValueType”/>
    </choice>
    <choice>
    <element name=“Field” type=“mp7qf:FieldType”/>
    <element name=“FieldCombination”
type=“mp7qf:FieldCombinationType”/>
    <element name=“ConstantValue”
    type=“mp7qf:ConstantValueType”/>
    </choice>
  </sequence>
</extension>
</complexContent>
</complexType>
```

6. The method of claim 1, wherein when two operands are disposed in the GT operator according to the following definition, the SOAP operation determines whether a great relationship between the two operands is True.
```
<complexType name=“GT”>
<complexContent>
<extension base=“mp7qf:ComparisonOperatorType”>
  <sequence>
      <choice>
      <element name=“Field” type=“mp7qf:FieldType”/>
      <element name=“FieldCombination”
type=“mp7qf:FieldCombinationType”/>
      <element name=“ConstantValue”
      type=“mp7qf:ConstantValueType”/>
      </choice>
      <choice>
      <element name=“Field” type=“mp7qf:FieldType”/>
      <element name=“FieldCombination”
type=“mp7qf:FieldCombinationType”/>
      <element name=“ConstantValue”
      type=“mp7qf:ConstantValueType”/>
      </choice>
  </sequence>
</extension>
</complexContent>
</complexType>
```

7. The method of claim 1, wherein when two operands are disposed in the LTE operator according to the following definition, the SOAP operation determines whether a little or equal relationship between the two operands is True.
```
<complexType name=“LTE”>
<complexContent>
<extension base=“mp7qf:ComparisonOperatorType”>
  <sequence>
    <choice>
    <element name=“Field” type=“mp7qf:FieldType”/>
    <element name=“FieldCombination”
type=“mp7qf:FieldCombinationType”/>
    <element name=“ConstantValue”
    type=“mp7qf:ConstantValueType”/>
    </choice>
    <choice>
    <element name=“Field”
    type=“mp7qf:FieldType”/>
    <element name=“FieldCombination”
type=“mp7qf:FieldCombinationType”/>
    <element name=“ConstantValue”
    type=“mp7qf:ConstantValueType”/>
    </choice>
  </sequence>
</extension>
</complexContent>
</complexType>
```

8. The method of claim 1, wherein when two operands are disposed in the LT operator according to the following definition, the SOAP operation determines whether a little relationship between the two operands is True.
```
<complexType name=“LT”>
<complexContent>
<extension base=“mp7qf:ComparisonOperatorType”>
  <sequence>
    <choice>
    <element name=“Field” type=“mp7qf:FieldType”/>
    <element name=“FieldCombination”
type=“mp7qf:FieldCombinationType”/>
    <element name=“ConstantValue”
    type=“mp7qf:ConstantValueType”/>
    </choice>
    <choice>
    <element name=“Field”
    type=“mp7qf:FieldType”/>
    <element name=“FieldCombination”
type=“mp7qf:FieldCombinationType”/>
    <element name=“ConstantValue”
    type=“mp7qf:ConstantValueType”/>
    </choice>
  </sequence>
</extension>
</complexContent>
</complexType>
```

9. The method of claim 1, wherein when two operands are disposed in the EQ operator according to the following definition, the SOAP operation determines whether a equal relationship between the two operands is True.
```
<complexType name=“EQ”>
<complexContent>
<extension base=“mp7qf:ComparisonOperatorType”>
  <sequence>
    <choice>
    <element name=“Field” type=“mp7qf:FieldType”/>
    <element name=“FieldCombination”
type=“mp7qf:FieldCombinationType”/>
    <element name=“ConstantValue”
    type=“mp7qf:ConstantValueType”/>
    </choice>
    <choice>
    <element name=“Field”
    type=“mp7qf:FieldType”/>
    <element name=“FieldCombination”
type=“mp7qf:FieldCombinationType”/>
    <element name=“ConstantValue”
    type=“mp7qf:ConstantValueType”/>
    </choice>
  </sequence>
</extension>
</complexContent>
</complexType>
```

10. The method of claim 1, wherein when two operands are disposed in the NE operator according to the following definition, the SOAP operation determines whether a non-equal relationship between the two operands is True.
```
<complexType name=“NE”>
  <complexContent>
    <extension base=“mpqf:ComparisonOperationType”>
      <choice>
          <group ref=“mpqf:ArithmeticOperands”/>
        <group ref=“mpqf:BooleanOperands”/>
        <group ref=“mpqf:DateTimeOperands”/>
          <group ref=“mpqf:DurationOperands”/>
        <group ref=“mpqf:StringOpeands”/>
      </choice>
    </extension>
  </complexContent>
</complexType>
```

11. The method of claim 1, wherein the SOAP operation is a class defining a contain operator in a query based on a comparison operation type, and determines whether a string succeeding a preceding string emerges.
```
<complexType name=“contain”>
  <complexContent>
    <extension base=“mpqf:ComparisonOperationType”>
      <sequence>
        <group ref=“mpqf:StringOperations”/>
      </sequence>
    </extension>
  </complexContent>
</complexType>
```

12. The method of claim 1, wherein the SOAP operation performs a comparison operation with other operand using an operation result value of other operator as an operand.

13. The method of claims 12, wherein the other operator is an arithmetic operator.

14. A computer-readable storage medium storing a command which performs each operation of a method for searching content by a Simple Object Access Protocol (SOAP) operation, the method being described in claims 1.
